(19) United States
(12) Patent Application Publication
(10) Pub. No.: US 2013/0111562 A1
(43) Pub. Date: May 2, 2013

(54) METHOD AND APPARATUS FOR DELIVERING APPLICATION SERVICE USING PRE-CONFIGURED ACCESS CONTROL CORRESPONDING TO ORGANIZATIONAL HIERARCHY

(71) Applicants: Jihyun LEE, Daejeon (KR); Hee Sun WON, Daejeon (KR); Sung Jin Hur, Daejeon (KR)

(72) Inventors: Jihyun LEE, Daejeon (KR); Hee Sun WON, Daejeon (KR); Sung Jin Hur, Daejeon (KR)

(73) Assignee: Electronics and Telecommunications Research Institute, Daejeon (KR)

(21) Appl. No.: 13/477,648

(22) Filed: May 22, 2012

(30) Foreign Application Priority Data
Oct. 31, 2011 (KR) 10-2011-0112067

(51) Int. Cl. G06F 21/00

(52) U.S. Cl. 726/4

(57) ABSTRACT

A method for delivering an application service defines an organizational hierarchy, defines an expanded role graph by mapping the organizational hierarchy to an authority structure in the form of a role graph, and defines a service creation policy based on authority information of each role depending on the expanded role graph. The method then creates a software service based on the defined authority information of each role.

### RELATED APPLICATION(S)

This application claims the benefit of Korean Patent Application No. 10-2011-0112067, filed on Oct. 31, 2011, which is hereby incorporated by reference as if fully set forth herein.

### FIELD OF THE INVENTION

The present invention relates to a method and apparatus for delivering an application service using pre-configured access control corresponding to an organizational hierarchy, and more particularly, to a method and apparatus for delivering an application service, which present an authority management structure corresponding to an organizational hierarchy and use it to configure a software service so that a person with authority can get an enterprise application service and use different accessible menus and functions based on authority.

### BACKGROUND OF THE INVENTION

An enterprise application is usually presented as a web application, and allows each individual department or team constituting a company to access the functions required to operate a business anywhere. From the viewpoint of an administrator who administers an enterprise application, situations requiring changes in accessible menus and functions of the enterprise application occur continuously due to a change in the company's organizational hierarchy, a personnel change, hiring of new employees, changes in business operations, etc. To deal with these changes, the administrator of the enterprise application configures the application to show employees only the menus related to their authority, and configures the application such that the functions operable on the web pages linked to the menus do not exceed the scope of their authority. A function for the configuration requires an authority management structure which can be changed and used any time as required, and this function has to operate based on a preset authority management structure.

Changes in authority management corresponding to an organizational hierarchy and changes in business processing functions require more complex access control in order to control a user of the application, a post delegated to the user, and the authority of the position. To solve the above issue, traditional access control models, such as discretionary access control (DAC) and mandatory access control (MAC), have been studied. However, the traditional access control models are subordinate to specific users because user access to information is based on individual identity, and do not allow detailed authority setting for an object due to access limitation based on the authority of a subject.

To overcome these constraints, research on role-based access control (RBAC), which is a general access control model, has been actively done. However, the role hierarchy proposed by RBAC has a limitation in presenting an authority management corresponding to an organizational hierarchy, which leads to an ambiguity problem about authority descriptions for roles and authority delegation.

### SUMMARY OF THE INVENTION

In view of the above, the present invention provides a method and apparatus for delivering an application service, which present an authority management structure corresponding to an organizational hierarchy and use it to configure a software service so that a person with authority can get an enterprise application service and use different accessible menus and functions based on authority.

In accordance with an aspect of the present invention, there is provided a method for delivering an application service, which includes: defining an organizational hierarchy; defining an expanded role graph by mapping the organizational hierarchy to an authority structure in the form of a role graph; defining a service creation policy based on authority information of each role depending on the expanded role graph; and creating a software service based on the defined authority information of each role.

In the method, the defining an organizational hierarchy includes: defining the organizational hierarchy as departments and teams, and wherein the departments are presented by the names of major categories and subsequent categories, and the subsequent categories are included in the departments of the major categories.

In the method, the defining an expanded role graph includes: defining the role graph, the role graph including information about a department to which a user of the organization belongs and information about authority that can use the application service.

In the method, the defining a service creation policy includes: defining UI components of the application service and detailed UI attribute of the components.

In the method, the defining a service creation policy includes: defining business logic to execute an operation as requested when a specific component is selected from a created web page.

In the method, wherein said creating a software service includes: creating the software service, wherein the software service includes at least one of accessible menu, a UI page, a UI page component or business logic for each role.

In the method, the creating a software service includes: offering menus to operate accessible functions.

In the method, the creating a software service includes: searching components of a web page for each role to create a UI page and links the UI page to the menus.

In the method, the creating a software service includes: allowing UI of an application service to be shown to a web browser; and operating pre-configured business logic as requested from a specific UI component.

In accordance with another aspect of the present invention, there is provided an apparatus for delivering an application service. The apparatus includes: an access control framework configured to define an organizational hierarchy, create an authority structure in the form of a role graph, mapping the organizational hierarchy to an authority structure in the form of a role graph to define an expanded role graph, and define a service creation policy based on authority of each role depending on the expanded role graph; and a software service delivery framework configured to create a software service based on the authority information of each role defined in the service creation policy.

Preferably, the access control framework includes: a service creation policy modeler configured to define and control access authority to an application; a service creation policy checker configured to check whether or not there exists inconsistency with an application service creation policy defined for the organizational hierarchy and each role; and a service policy repository configured to store the service creation policy.

Preferably, the service creation policy checker is configured to check a role-based authority prior to the creation of the software service so as to create the software service as defined in the service creation policy.

Preferably, the service creation policy modeler includes: a role-access control definer configured to define the access authority for each role; a rule-function definer configured to create, functions of an application service and rules of the roles having the functions; an organizational hierarchy definer configured to define information about departments and teams of the organizational hierarchy; a user-role assigner configured to assign roles to users of the application service; a rule-constraint definer configured to define constraints on the roles and organizational hierarchy when creating the application service; and a user-department assigner configured to assign users to the defined organizational hierarchy.

Preferably, the software service delivery framework includes: a meta data repository configured to store UI page configuration information for creating UI pages and structural information of business data related to an application service that operates on a UI page; a UI meta handler configured to extract the UI page configuration information based on the users and roles from the meta data repository; a data schema handler configured to extract structural information of business data related to the application service that operates on the UI page from the meta data repository; a service data repository configured to store the business logic; a business logic meta handler configured to extract, from the service data repository, a script code, a service implementation code, and workflow description information that are required to perform work-related tasks in the application service; and a real-time execution engine configured to identify, in response to a request for the application service from a service user, role for the service user to create a service that offers the functions and UI based on the identified role in real time.

The real-time execution engine is configured to: combine the UI configuration information, extracted from the UI meta handler, the data schema handler and the business logic meta handler, a data object for making a query and changing the application service, and business logic to create a structured service in the form of web pages; and execute an operation as requested from a UI-specific component in order to show an execution result thereof.

### BRIEF DESCRIPTION OF THE DRAWINGS

The above and other objects and features of the present invention will become apparent from the following description of embodiments, given in conjunction with the accompanying drawings, in which:

FIG. 1 is a block diagram of an apparatus for delivering an application service using pre-configured access authority in accordance with an embodiment of the present invention;

FIG. 2 exemplarily illustrates the definition of an organizational hierarchy;

FIG. 3 illustrates an example in which an expanded role graph corresponding to an organizational hierarchy is created in accordance with an embodiment of the present invention;

FIG. 4 is a flowchart illustrating a method for creating a service policy in accordance with an embodiment of the present invention;

FIG. 5 illustrates a structure for storing data included in a role graph expanded for service creation in accordance with an embodiment of the present invention;

FIG. 6 shows components for structuralizing an application service;

FIG. 7 exemplarily illustrates a web page configured based on a service creation policy defined in accordance with an embodiment of the present invention; and

FIG. 8 is a flowchart illustrating a method of creating a service based on a creation policy and processing an operation request issued after the creation in accordance with an embodiment of the present invention.

### DETAILED DESCRIPTION OF THE EMBODIMENTS

The advantages and features of the present invention and methods of accomplishing these advantages and features will be clearly understood from the following description of various embodiments taken in conjunction with the accompanying drawings. However, the present invention is not limited to the following description and is intended to cover alternatives, modifications, and equivalents that may be included within the spirit and scope of the invention as defined in the appended claims. It should be noted that the present description is provided to describe and explain, but not limit, the invention.

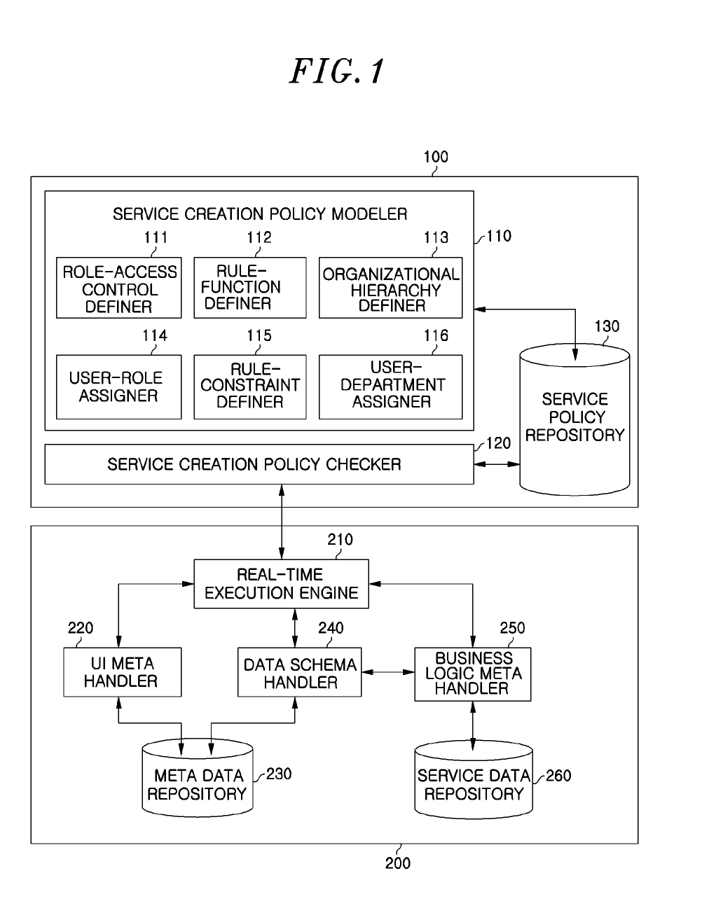

FIG. 1 is a block diagram of an apparatus for delivering an application service using pre-configured access authority (access control information) in accordance with an embodiment of the present invention.

The task of manually managing an application depending on a change in a company's organizational hierarchy, hiring of new employees, a personnel change, changes in business tasks, and so on is subject to many errors and difficult to implement. Thus, it is benefit to provide a solution for creating an application that separates authority structure management and application service creation, defines authorities, and reflects the authorities set for an application service as defined. The application service delivery apparatus shown in FIG. 1 allows an enterprise application to be created and operated in the form of “software as a service (SaaS)” based on the organizational hierarchy of a company and the authority structure of service users.

The application service delivery apparatus includes an access control framework 100 and a software service delivery framework 200.

The access control framework 100 includes a service creation policy modeler 110, a service creation policy checker 120, and a service policy repository 130.

The service creation policy modeler 110 defines and controls access authority to the application. The service creation policy modeler 110 includes a role-access control definer 111 for defining the authority for each role, a rule-function definer 112 for creating the functions of an application service and rules assigned to the roles performing the functions, an organizational hierarchy definer 113 for defining departments and teams of an organizational hierarchy, a user-role assigner 114 for assigning roles to users of the application service, a rule-constraint definer 115 for defining constraints on the roles and organizational hierarchy when creating an application service, and a user-department assigner 116 for assigning users to the defined organizational hierarchy.

The service policy repository 130 stores rules for creating and providing a service.

The service creation policy checker 120 checks whether or not there exists inconsistency after an application service creation policy is defined for the organizational hierarchy and each role. Further, the service creation policy checker 120 checks a role-based authority prior to service creation so as to create a service as defined in the creation policy.

The software service delivery framework 200 includes a real-time execution engine 210, a UI meta handler 220, a meta data repository 230, a data schema handler 240, a business logic meta handler 250, and a service data repository 260.

The meta data repository 230 stores UI page configuration information for creating UI pages and structural information of business data related to an application service that operates on the UI pages.

The UI meta handler 220 extracts the UI page configuration information stored in the meta data repository 230 based on the user and role information because a viewable UI and executable business logic are different for each role.

The data schema handler 240 extracts structural information of business data related to an application service that operates on an UI page from the meta data repository 230.

The service data repository 260 stores business logic.

The business logic meta handler 250 extracts, from the service data repository 260, a script code, a service implementation code, and workflow description information that are required to perform work-related tasks in an application service.

When a service user logs in to a portal site through a web browser to request an application service, the real-time execution engine 210 identifies a role of the service user and creates a service that offers the functions and UI based on the identified role in real time. Also, the real-time execution engine 210 combines the UI configuration information that is extracted from the UI meta handler 220, the data schema handler 240 and the business logic meta handler 250, a data object queried and changed to perform the application service, and business logic to create a structured service in the form of web pages, and executes an operation as requested from a UI-specific component to show an execution result.

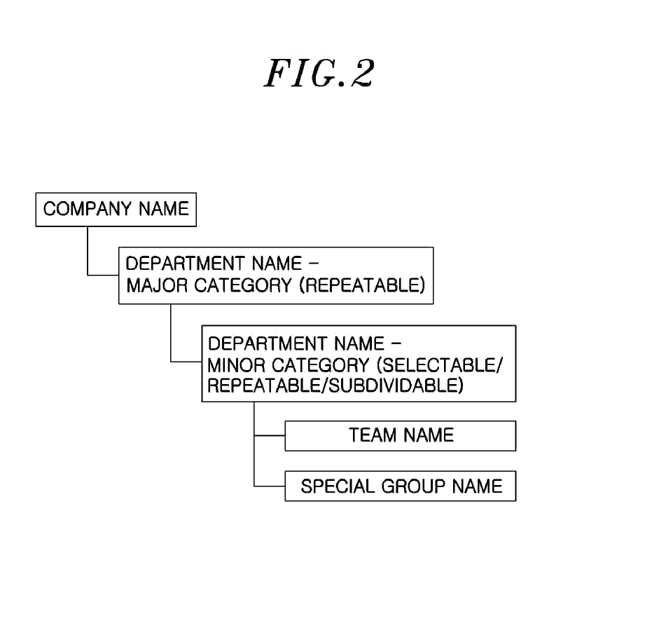

FIG. 2 is a schematic view exemplarily illustrating the definition of an organizational hierarchy.

The organizational hierarchy definer 113 defines the organizational hierarchy of a company as departments and teams, defines sub-departments that can be included in the name of a department that can be presented by major categories and subsequent categories, and defines sub-departments again if required. Once the organizational hierarchy is defined, the user-department assigner 116 is used to assign users to the organizational hierarchy. This allows a service user to be assigned to a specific department, and to belong thereto without overlaps.

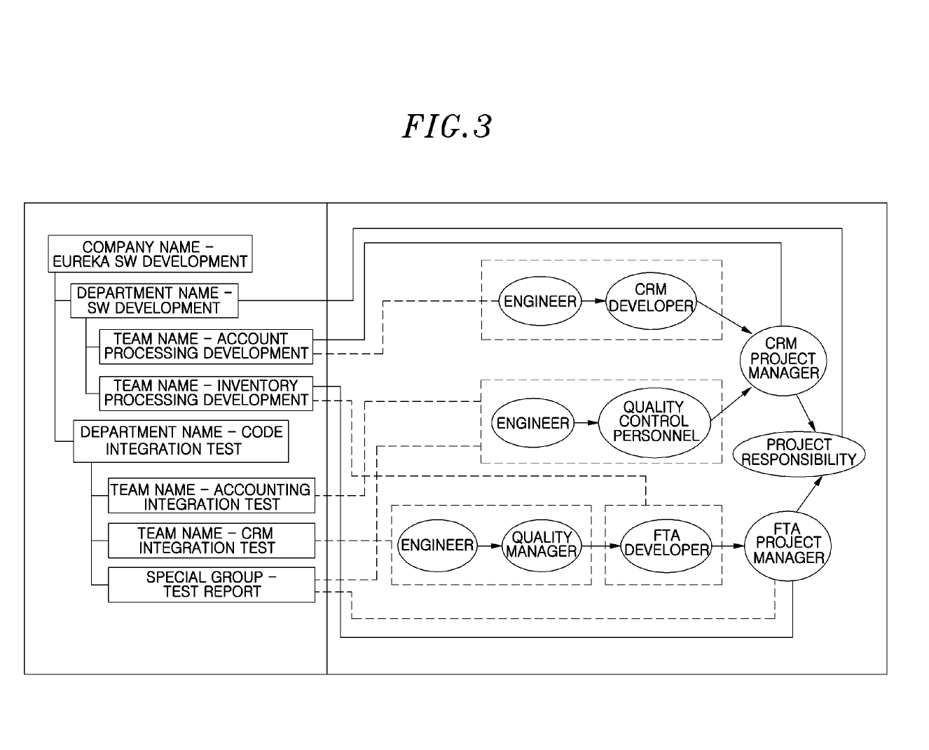

FIG. 3 is a schematic view illustrating an example in which an expanded role graph (the left-side of drawing) corresponding to an organizational hierarchy (the right-side of drawing) is created in accordance with an embodiment of the present invention. Roles required performing business operations of a company are defined as follows. A method of definition uses the following notation summarized in Table 1.

TABLE 1

| Category | Attribute Details | Meanings in Role Graph |
|---|---|---|
| Node (N) | Label | Role name |
| | Numbering | Vᵢ, ⱼ (i: role rank, j: |
| | | department) |
| | Uppermost Root | The most senior role |
| | Shape | Eclipse for a role |
| | | Rectangle for a role group |
| | Null middle vertex | Pointer to role sub-graph |
| | Non-null middle | Middle level role |
| | vertex | |
| | Leaf | The most junior role |
| | Double rounded | User-role assignment with a |
| | labeled leaf | label, user name |
| Edge (E) | Line shape | Default connection between |
| | | nodes |
| | Dotted line | Indication of relationship |
| | | of delegation of authority |
| | | with constraints |
| | One arrowed head | If there exists no |
| | | constraint for a role (in |
| | | default) |
| | Double arrowed head | If there exists an |
| | | inheritance constraint for a |
| | | role |
| | Direction | Direction of role delegation |
| | | (upward (default) or |
| | | downward) |
| Sub- | Sub-graph | Sub-graph belonging to role |
| graph (S) | | graph (limited role |
| | | hierarchy) |

Table 1 is the notation for defining a role graph, which defines a node, an edge between nodes, and a sub-graph. A node may be labeled with a role name, and a node may be numbered with (i, j) to indicate a task name and a belonged department. The root node in the highest level indicates an organization name. Edges specify temporal and spatial constraints required for business operations due to belonged departments and assignments. A constraint is defined as if(condition)then{action1}else{action2}, and configured depending on the grammar of a script language used to implement a service.

The role graph in FIG. 2 takes a form of graph plotted using nodes and edges. In the hierarchical relationship of roles, a role in higher rank is indicated as having more authority, and a role in lower rank is indicated as having less authority. Each node is used to indicate a role, and each individual user in a department of the organization is assigned with one or more roles.

For example, FIG. 3 illustrates that the head of the “SW development” department is endowed with the role of “CRM project manager”, and users belonging to the “accounting integration test” team are endowed with the role of “quality control personnel” of the CRM project. “Quality control personnel” include all the roles of “Engineer” name, by which the functions required for quality control of the CRM project can be executed in the enterprise application service.

To correspond to the organizational hierarchy after creating a role graph, a user of the organization needs to be mapped to a defined role so that the user can utilize the application service. This enables the user of the organization to have the role through the user-role assigner 114, thereby creating an expanded role graph.

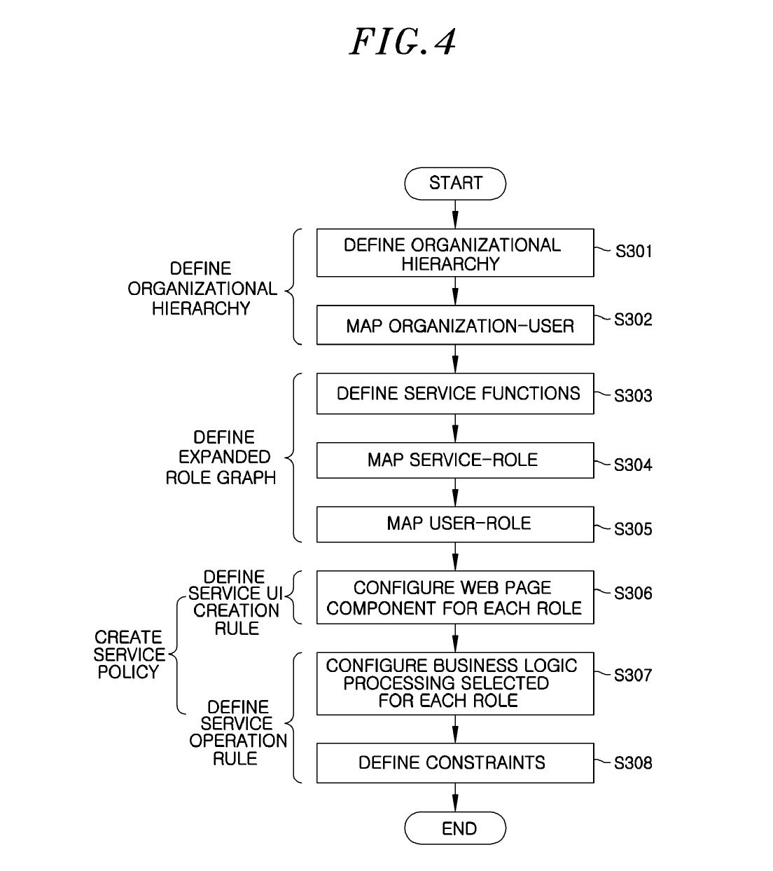

FIG. 4 is a flowchart illustrating a method for creating a service policy.

A service policy is created after defining an organizational hierarchy and an expanded role graph. The role-access control definer 111 and the rule-function definer 112 are used to define the service policy. To dynamically create a service for each role, there is a need for a method that stores unit components of the service by component and extracts the stored unit components to combine them in the form of a service. To this end, a service creation and operation policy is created through the steps shown in FIG. 4.

First, an organizational hierarchy is defined in step S301, and users are assigned to the organizational hierarchy to map organization-user information in step S302.

Service functions are then defined in step S303, and the roles for each service are mapped to the definitions of service functions to define which role is to execute a specific function in step S304. After a role is mapped to a service, users are assigned to define which specific user is to execute which function of the service in step S305.

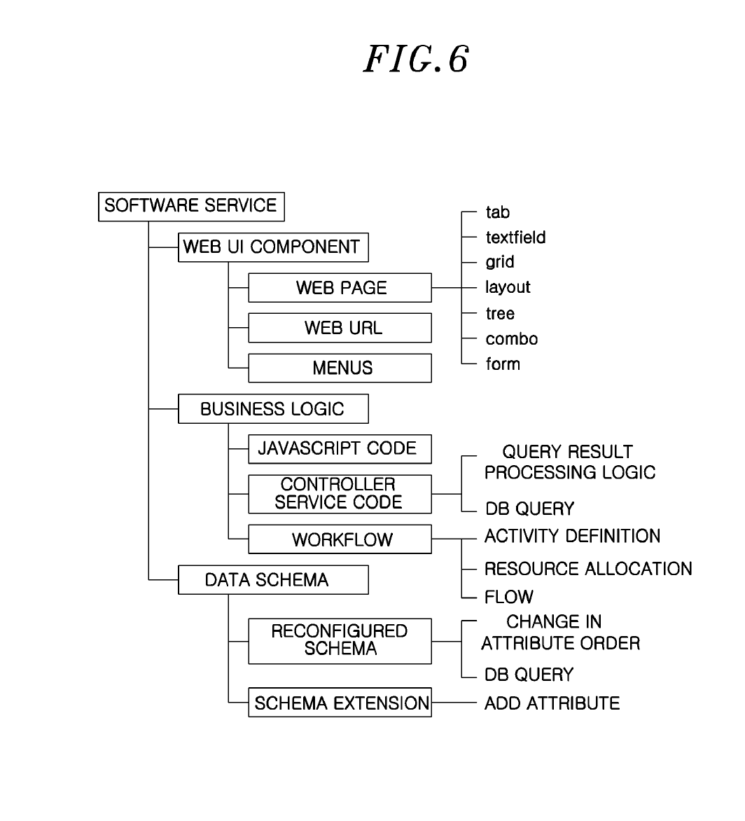

A web page for each role is configured for a target component so as to dynamically create a service for each role in step S306. The configuration information is based on the configuration defined as shown in FIG. 6. The configuration information is roughly divided into a UI page component, a business logic component, and a data schema component. Each of these three components has sub-components.

A web page created by extracting a UI page component for each role is shown to a user through a web browser. From a selected UI component, business logic can be executed in the form of a preset script or DB query. In this manner, a service operation is configured to process business logic for each role in step S307, and constraints are defined in step S308. The constraints are defined for the number of a department to which the user belongs to and the number of an assignment that he user has to execute.

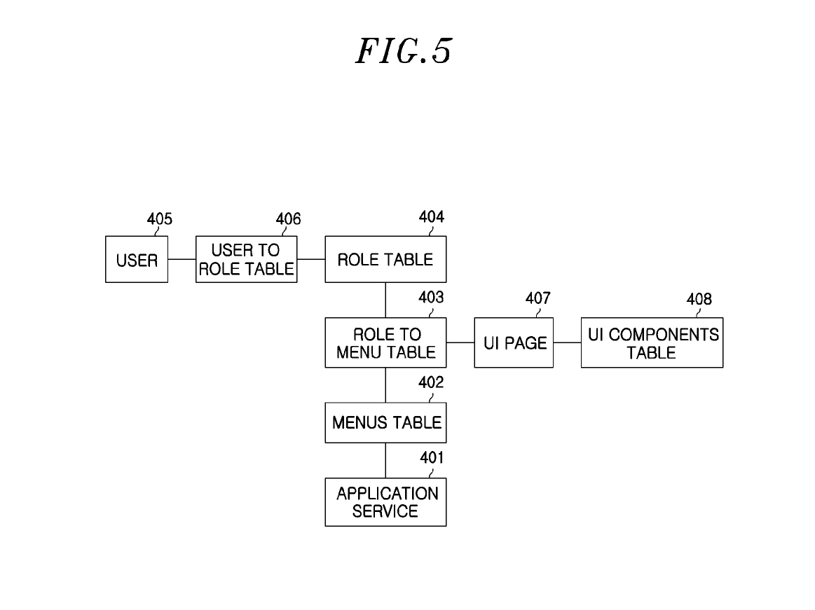

FIG. 5 illustrates a structure for storing data included in a role graph expanded for service creation. The expanded role graph has a structure of nodes and edges as shown in FIG. 3, and authority management data included in the expanded role graph is stored and managed in the structure as shown in FIG. 5.

An application service 401 manages a menus table 402, and provides menus defined in the menus table 402 based on a role, and a role to menu table 403 stores the menus provided from the application service 401.

Roles are defined in a role table 404, and a role assigned to a user 405 is defined in a user to role table 406.

A specific menu is associated with a specific UI page 407 depending on data defined in the role to menu table 403. A menu serves as a starting point at which a user-accessible service function for each role is changed. The components of the UI page 407 are stored in a UI components table 408.

FIG. 6 illustrates components for structuralizing a software service. The software service is roughly divided into a web UI component (UI page), a business logic component, and a data schema component. Each of these three components has sub-components.

The web UI component includes a web page, a web URL, and menus, and the web page component consists of tabs, textfields, grids, layouts, trees, comboboxes, forms, and so on.

The business logic component includes three elements: a JavaScript code, a controller service code, and a workflow, and is divided into script-based logic for processing simple calculations such as the average value and maximum value, and code-based logic for executing a DB query to get a processing result and performing a business operation. The controller service code includes query result processing logic, a DB query, etc., and the workflow includes activity definition, resource allocation, flow, etc.

The data schema component includes reconfigured schema and schema extension. The reconfigured schema includes a change in attribute order, a DB query, etc., and the schema extension includes an attribute addition, etc.

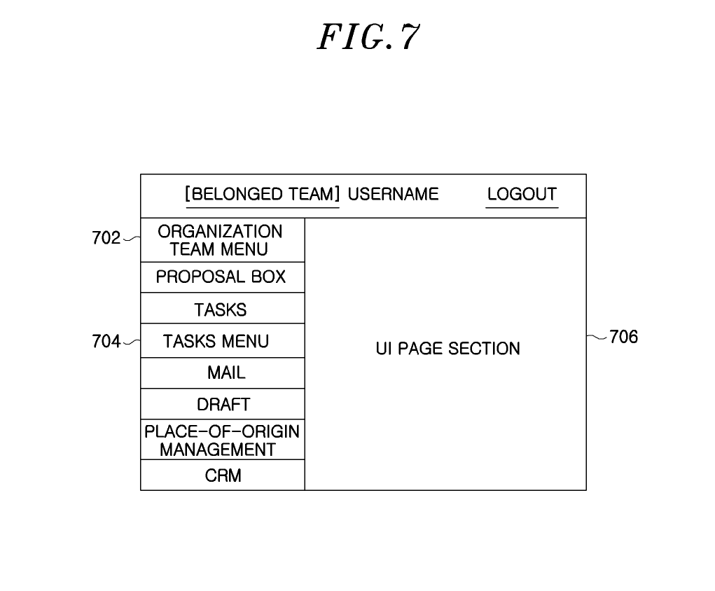

FIG. 7 illustrates an exemplary web page configured based on a service creation policy defined as explained in FIG. 4.

In a web page, the menus on the left are divided into two upper and lower sections: “an organization team menu” 702 and “a task menu” 704. The organization team menu 702 is changed on the web page based on information of a department to which a user belongs, and the task menu 704 associated with business operations is changed on the web page based on an assignment number to be executed by the user. Further, a web page linked to an “UI page section” 706 is shown based on a selected menu. On the uppermost side, the user name and information about the team to which the user belongs are shown.

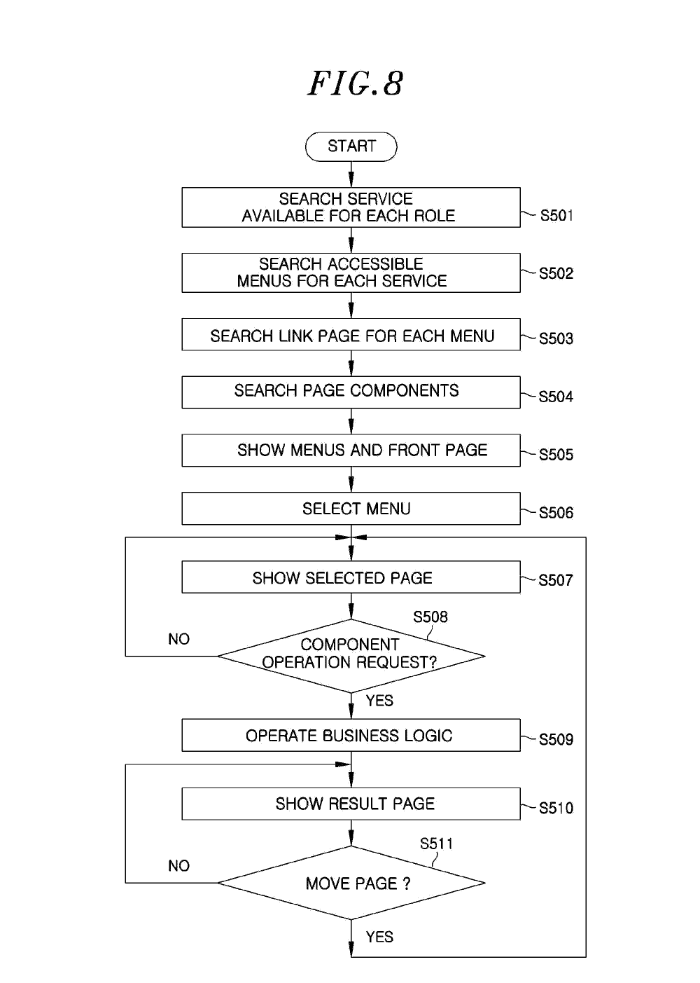

FIG. 8 is a flowchart illustrating a method of creating a service based on a creation policy and processing an operation request issued after the creation in accordance with an embodiment of the present invention.

When a user has logged in to a specific URL to use the application service, in step S501, a service available for each role is searched from the information defined in FIG. 4 to identify which role is assigned with the user. To achieve that the service name is shown on the “Tasks Menu” of FIG. 7 and the menus of the service are shown in the subcategories under the service, accessible menus for each service are searched in step S502.

A link page for each menu is then searched in step S503, and the components of each page are searched in step S504. When information about the menus-pages-components is searched and the configuration of pages for all the menus is completed, the menus and the front page are shown in step S505. The menus have information about menu_id, menu_url, menu_name, menu_order, page_id, and parent_menu, which are stored in the menu table. Thus, the upper and lower sides of the menus show the analysis of the numbers shown in menu_order, and have parent_menu so as to move from the displayed menu screen to the parent menu screen.

When a menu is selected in step S506, a web page corresponding to the selected menu is shown in step S507. When there is a component operation request in step S508, a business logic corresponding to the request is operated in step S509 to show a result page in step S510. Also, when Move Page is selected in step S511, the procedures subsequent to the step S507 are performed repeatedly.

When Logout is selected while executing the method, the method is finished.

In accordance with the embodiment of the present invention, a method and apparatus, which present an authority management structure corresponding to an organizational hierarchy and use it to configure software so that a person with authority can get an enterprise application service and use different accessible menus and functions based on authority, are provided. Thus, it is possible to solve the problems which occur when the conventional role-based access control provides authority control based on the role of an organization and provide more solid security for a business enterprise application.

While the invention has been shown and described with respect to the particular embodiments, the present invention is not limited thereto. It will be understood by those skilled in the art that various changes and modification may be made without departing the scope of the invention defined in the following claims.

What is claimed is:

1. A method for delivering an application service, the method comprising:
defining an organizational hierarchy;
defining an expanded role graph by mapping the organizational hierarchy to an authority structure in the form of a role graph;
defining a service creation policy based on authority of each role depending on the expanded role graph; and
creating a software service based on the defined authority information of each role.

2. The method of claim 1, wherein said defining an organizational hierarchy comprises:
defining the organizational hierarchy as departments and teams, and
wherein the departments are presented by the names of major categories and subsequent categories, and the subsequent categories are included in the departments of the major categories.

3. The method of claim 1, wherein said defining an expanded role graph comprises:
defining the role graph, the role graph including information about a department to which a user of the organization belongs and information about authority that can use the application service.

4. The method of claim 1, wherein said defining a service creation policy comprises:
defining UI components of the application service and detailed UI attribute of the components.

5. The method of claim 1, wherein said defining a service creation policy comprises:
defining business logic to execute an operation as requested when a specific component is selected from a created web page.

6. The method of claim 1, wherein said creating a software service comprises:
creating the software service, wherein the software service includes at least one of accessible menu, a UI page, a UI page component or business logic for each role.

7. The method of claim 1, wherein said creating a software service comprises:
offering menus to operate accessible functions.

8. The method of claim 7, wherein said creating a software service comprises:
searching components of a web page for each role to create a UI page and links the UI page to the menus.

9. The method of claim 1, wherein said creating a software service comprises:
allowing UI of an application service to be shown to a web browser; and
operating pre-configured business logic as requested from a specific UI component.

10. An apparatus for delivering an application service, the apparatus comprising:
an access control framework configured to define an organizational hierarchy, create an authority structure in the form of a role graph, mapping the organizational hierarchy to an authority structure in the form of a role graph to define an expanded role graph, and define a service creation policy based on authority of each role depending on the expanded role graph; and
a software service delivery framework configured to create a software service based on the authority information of each role defined in the service creation policy.

11. The apparatus of claim 10, wherein the access control framework comprises:
a service creation policy modeler configured to define and control access authority to an application;
a service creation policy checker configured to check whether or not there exists inconsistency with an application service creation policy defined for the organizational hierarchy and each role; and
a service policy repository configured to store the service creation policy.

12. The apparatus of claim 11, wherein the service creation policy checker is configured to check a role-based authority prior to the creation of the software service so as to create the software service as defined in the service creation policy.

13. The apparatus of claim 11, wherein the service creation policy modeler comprises:
a role-access control definer configured to define the access authority for each role;
a rule-function definer configured to create, functions of an application service and rules of the roles having the functions;
an organizational hierarchy definer configured to define information about departments and teams of the organizational hierarchy;
a user-role assigner configured to assign roles to users of the application service;
a rule-constraint definer configured to define constraints on the roles and organizational hierarchy when creating the application service; and
a user-department assigner configured to assign users to the defined organizational hierarchy.

14. The apparatus of claim 10, wherein the software service delivery framework includes:
a meta data repository configured to store UI page configuration information for creating UI pages and structural information of business data related to an application service that operates on a UI page;
a UI meta handler configured to extract the UI page configuration information based on the users and roles from the meta data repository;
a data schema handler configured to extract structural information of business data related to the application service that operates on the UI page from the meta data repository;
a service data repository configured to store the business logic;
a business logic meta handler configured to extract, from the service data repository, a script code, a service implementation code, and workflow description information that are required to perform work-related tasks in the application service; and
a real-time execution engine configured to identify, in response to a request for the application service from a service user, role for the service user to create a service that offers the functions and UI based on the identified role in real time.

15. The apparatus of claim 14, wherein the real-time execution engine is configured to:
combine the UI configuration information, extracted from the UI meta handler, the data schema handler and the business logic meta handler, a data object for making a query and changing the application service, and business logic to create a structured service in the form of web pages; and
execute an operation as requested from a UI-specific component to show an execution result thereof.
